(19) United States
(12) Patent Application Publication
(10) Pub. No.: US 2026/0163130 A1
(43) Pub. Date: Jun. 11, 2026

(54) DEVICE AND METHOD FOR ATTACHING TAPE FOR SECONDARY BATTERY

(71) Applicant: SAMSUNG SDI CO., LTD., Yongin-si (KR)

(72) Inventor: Seungchan LEE, Yongin-si (KR)

(21) Appl. No.: 19/181,504

(22) Filed: Apr. 17, 2025

(30) Foreign Application Priority Data
Aug. 7, 2024 (KR) 10-2024-0105399

(51) Int. Cl. H01M 50/14; H01M 10/04; H01M 50/102

(52) U.S. Cl. CPC H01M 50/14; H01M 10/0404; H01M 10/0481; H01M 50/102

(57) ABSTRACT

A device for attaching a tape includes a support block configured to support a lower surface of an electrode assembly to which a protective tape is attached, a bending block spaced apart from a side surface of the support block, the bending block including air spray holes facing the side surface of the support block and a side surface of the electrode assembly, and the bending block being configured to attach the protective tape to the side surface of the electrode assembly, and a bending roller above the bending block, the bending roller being movable along an upper surface of the bending block and an upper surface of the electrode assembly to attach the protective tape to the upper surface of the electrode assembly.

### CROSS-REFERENCE TO RELATED APPLICATION

The present application claims priority to and the benefit of Korean Application No. 10-2024-0105399, filed on Aug. 7, 2024, in the Korean Intellectual Property Office, the entire disclosure of which is incorporated by reference herein.

### BACKGROUND

### 1. Field

Aspects of embodiments of the present disclosure relate to a device and method for attaching a tape for a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The electrode assembly may be classified into a stacked electrode assembly in which a positive electrode plate, a separator, and a negative electrode plate are sequentially stacked, or a wound electrode assembly in which a positive electrode plate, a separator, and a negative electrode plate are sequentially stacked and wound. A protective tape may be attached to the surface of the electrode assembly, and the protective tape may serve to protect and maintain the positive electrode plate, the separator, and the negative electrode plate in an aligned state so that the positive electrode plate, the separator, and the negative electrode plate do not fall or misalign.

The above information disclosed in this Background section is for enhancement of understanding of the background of the present disclosure, and therefore, it may contain information that does not constitute related (or prior) art.

### SUMMARY

A device for attaching a tape according to some embodiments of the present disclosure may include a support block supporting a lower surface of an electrode assembly to which a protective tape protruding in a lateral direction is attached; a bending block spaced apart from a side surface of the electrode assembly and attaching the protective tape to the side surface thereof; and a bending roller moving along an upper surface of the electrode assembly to attach the protective tape to the upper surface thereof, wherein the bending block may include an air spray hole disposed to face the side surface of the electrode assembly.

According to some embodiments of the present disclosure, the protective tape protruding in the lateral direction may be bent to face the side surface of the electrode assembly, and the bending block may spray compressed air to the bent protective tape through the air spray hole.

According to some embodiments of the present disclosure, a pressure of the compressed air sprayed through the air spray hole may be 0.1 MPa to 0.3 MPa.

According to some embodiments of the present disclosure, the air spray hole may be disposed at a height corresponding to half of a height of the side surface of the electrode assembly.

According to some embodiments of the present disclosure, a diameter of the air spray hole may be 20% to 30% of the height of the side surface of the electrode assembly.

According to some embodiments of the present disclosure, a diameter of the air spray hole may be 2 mm or less.

According to some embodiments of the present disclosure, a separator may protrude from the side surface of the electrode assembly, and a distance by which the bending block is spaced apart from the side surface may be longer than a length by which the separator protrudes from the side surface.

According to some embodiments of the present disclosure, the distance by which the bending block is spaced apart from the side surface may be 1 mm to 2 mm.

According to some embodiments of the present disclosure, the bending block may include a plurality of air spray holes, and a plurality of air spray holes may be spaced apart from each other along a length direction of the side surface of the electrode assembly.

According to some embodiments of the present disclosure, a separation distance between the air spray holes may be 4 mm to 6 mm.

According to some embodiments of the present disclosure, the bending roller may pressurize the protective tape protruding toward the upper surface of the electrode assembly while bending the protective tape along the upper surface of the electrode assembly.

According to some embodiments of the present disclosure, at least a portion of a region where the support block, the bending block, or the bending roller comes into contact with the electrode assembly or the protective tape may be formed of an engineering plastic material.

A method for attaching a tape according to some embodiments of the present disclosure may include an operation of disposing, on a support block, a lower surface of an electrode assembly to which a protective tape protruding in a lateral direction is attached; an operation of attaching the protective tape to a side surface of the electrode assembly by using a bending block; and an operation of attaching the protective tape to an upper surface of the electrode assembly by using the bending block, wherein the bending block may include an air spray hole disposed to face the side surface of the electrode assembly, and the protective tape may come into close contact with the side surface of the electrode assembly by compressed air sprayed through an air spray hole.

According to some embodiments of the present disclosure, a first section of the protective tape may be attached to the lower surface of the electrode assembly, and a second section connected to the first section may protrude in a lateral direction of the electrode assembly, and the operation of disposing may include disposing the second section of the protective tape so as to be bent to face the side surface of the electrode assembly.

According to some embodiments of the present disclosure, the operation of attaching the protective tape to the side surface of the electrode assembly may include bringing a 2_1 section of the second section adjacent to the first section into close contact with the side surface of the electrode assembly, so that a 2_2 section of the second section of the protective tape adjacent to the 2_1 section may protrude toward the upper surface of the electrode assembly.

According to some embodiments of the present disclosure, the operation of attaching the protective tape to the upper surface of the electrode assembly may include attaching the 2_2 section of the protective tape to the upper surface of the electrode assembly while the bending roller moves along the upper surface of the electrode assembly.

According to some embodiments of the present disclosure, a pressure of the compressed air sprayed through the air spray hole may be 0.1 MPa to 0.3 MPa.

According to some embodiments of the present disclosure, the air spray hole may be disposed at a height corresponding to half of a height of the side surface of the electrode assembly.

According to some embodiments of the present disclosure, a diameter of the air spray hole may be 2 mm or less.

According to some embodiments of the present disclosure, a separator may protrude from the side surface of the electrode assembly, and a distance by which the bending block is spaced apart from the side surface may be longer than a length by which the separator protrudes from the side surface.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view showing an example of a battery cell according to an embodiment of the present disclosure.

FIG. 2 illustrates a block diagram showing a configuration of a device for attaching a tape according to an embodiment of the present disclosure.

FIG. 3 illustrates a stages in a method for attaching a tape according to an embodiment of the present disclosure.

FIG. 4 illustrates a stages in a method for attaching a tape according to an embodiment of the present disclosure.

FIG. 5 illustrates an example in which a protective tape is attached to a side surface of an electrode assembly according to an embodiment of the present disclosure.

FIG. 6 illustrates an example in which a protective tape is attached to a side surface of an electrode assembly according to an embodiment of the present disclosure.

FIG. 7 illustrates a method for attaching a tape according to an embodiment of the present disclosure.

FIG. 8 illustrates a plan view showing an example of a bending block according to an embodiment of the present disclosure.

FIG. 9 illustrates a battery cell manufactured by a device for attaching a tape according to a comparative example.

FIG. 10 illustrates a flowchart showing a method for attaching a tape according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

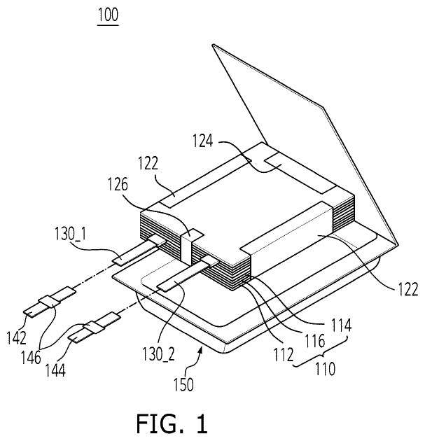

FIG. 1 illustrates a perspective view showing an example of a battery cell 100 according to an embodiment of the present disclosure. As illustrated in FIG. 1, the battery cell 100 may include a case 150 and an electrode assembly 110 disposed inside the case 150.

The electrode assembly 110 may include a first electrode 112, a second electrode 114, and a separator 116. For example, the electrode assembly 110 may be formed in a stack type structure including the first electrode 112 and the second electrode 114 (each of which may be formed of a plurality of sheets that are alternately stacked) with the separator 116 (which is an insulator) provided therebetween. In another example, the electrode assembly 110 may be formed as a winding type structure in which the first electrode 112 and the second electrode 114 are wound with the separator 116 provided therebetween. In addition, the electrode assembly 110 may be a Z-stack electrode assembly in which the first electrode 112 and the second electrode 114 are inserted on both sides of the separator 116 bent in a Z-stack.

The electrode assembly 110 may be accommodated in the case 150 by stacking one or more electrode assemblies 110 so that long sides thereof are adjacent to each other. In In the electrode assembly 110, the first electrode 112 may serve as a negative electrode and the second electrode 114 may serve as a positive electrode, e.g., the opposite is also possible.

The first electrode 112 may be formed by applying an active material, such as graphite or carbon, to a substrate formed of a metal foil, such as copper, a copper alloy, nickel, or a nickel alloy, and may include an uncoated portion, which is a region where the active material is not applied. A first substrate tab 130_1 may be connected to the uncoated portion of the first electrode 112. In some examples, the first substrate tab 130_1 may be formed by cutting to protrude toward one side in advance in a case of manufacturing the first electrode 112, and may further protrude toward one side than the separator 116 without separate cutting.

The second electrode 114 may be formed by applying an active material, such as a transition metal oxide, to a substrate formed of a metal foil, such as aluminum or an aluminum alloy, and may include an uncoated portion, which is a region where the active material is not applied. A second substrate tab 130_2 may be connected to the uncoated portion of the second electrode 114. In some examples, the second substrate tab 130_2 may be formed by cutting to protrude toward the other side in advance in a case of manufacturing the second electrode 114, and may further protrude toward the other side than the separator 116 without separate cutting.

The first substrate tab 130_1 may serve as a passage for current flow between the first electrode 112 and a first lead tab 142. A tab film 146 for insulation from the case 150 may be attached to the first lead tab 142. The second substrate tab 130_2 may serve as a passage for current flow between the second electrode 114 and a second lead tab 144. The tab film 146 for insulation from the case 150 may be attached to the second lead tab 144.

Protective tapes 122, 124, and 126 may be attached to the surface of the electrode assembly 110. The protective tapes 122, 124, and 126 may be attached along the side circumference of the electrode assembly 110. The protective tapes 122, 124, and 126 may align the electrode assembly 110 and protect the electrode assembly 110 from external impact.

The case 150 may form the overall exterior of the battery cell 100 and may provide a space in which the electrode assembly 110 is accommodated. The case 150 may be composed of conductive metal such as aluminum, an aluminum alloy, or nickel-plated steel, or a laminated film or plastic that constitutes a pouch.

FIG. 1 illustrates that the case 150 is a pouch type case and the battery cell 100 is a pouch type battery. However, the battery cell 100 may be a battery cell of any shape, such as a prismatic shape, a cylindrical shape, or a pouch shape.

The battery cell 100 may be a type of secondary battery. For example, the battery cell 100 may be a lithium battery cell, a sodium battery cell, or the like. However, the battery cell 100 may include any battery that is capable of repeatedly providing electricity through charging and discharging.

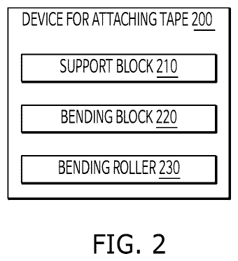

FIG. 2 illustrates a block diagram showing a configuration of a device 200 for attaching a tape according to an embodiment of the present disclosure. Referring to FIG. 2, the device 200 for attaching a tape may include a support block 210, a bending block 220, and a bending roller 230.

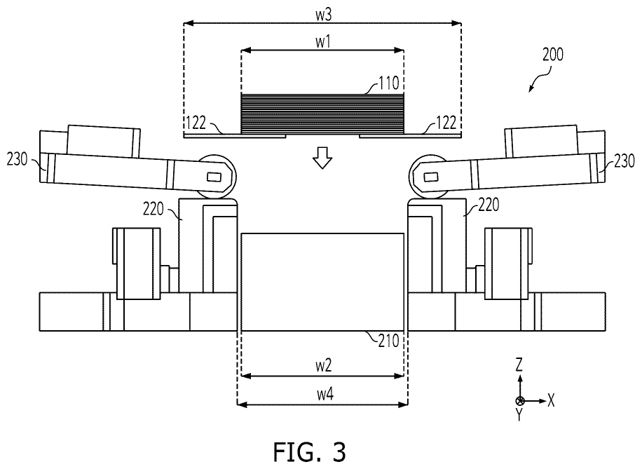

The support block 210 may support the electrode assembly. A protective tape may be attached to the lower surface of the electrode assembly. The protective tape may be attached so as to protrude toward the side surface of the electrode assembly. The electrode assembly to which the protective tape is attached may be disposed on the support block 210. The support block 210 may support the lower surface of the electrode assembly at the bottom of the electrode assembly. An example in which the electrode assembly is disposed on the support block is described in detail below with reference to FIG. 3.

The bending block 220 may be spaced apart from the side surface of the electrode assembly disposed on the support block 210. The bending block 220 may attach the protective tape to the side surface of the electrode assembly.

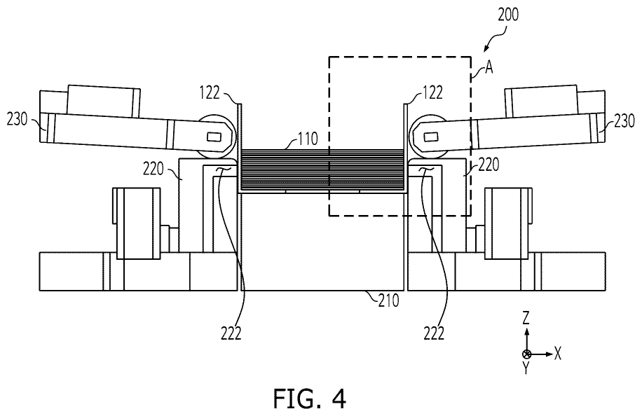

The bending block 220 may include air spray holes disposed to face the side surface of the electrode assembly. Compressed air may be sprayed from the air spray holes of the bending block 220. Due to the compressed air sprayed through the air spray holes, the protective tape may come into close contact with the side surface of the electrode assembly. An example in which the protective tape is attached to the side surface of the electrode assembly is described in detail below with reference to FIGS. 4 to 6.

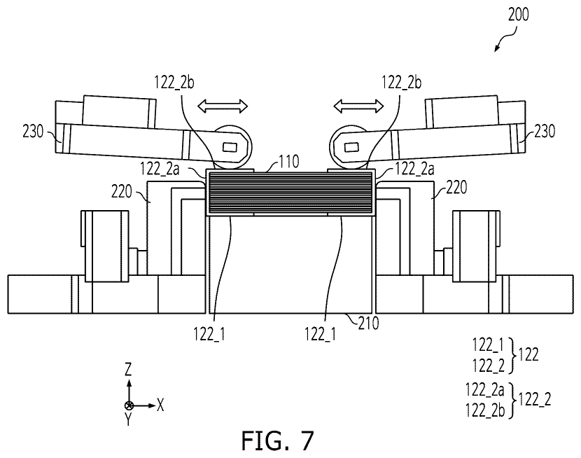

The bending roller 230 may be disposed above the bending block 220. The bending roller 230 may move along the upper surface of the electrode assembly and attach the protective tape to the upper surface of the electrode assembly. An example in which the protective tape is attached to the upper surface of the electrode assembly by the bending roller 230 is described in detail below with reference to FIG. 7.

In an embodiment, at least a portion of the support block 210, the bending block 220, or the bending roller 230 may be formed of an engineering plastic material. For example, at least a portion of a region where the support block 210, the bending block 220, or the bending roller 230 comes into contact with the electrode assembly or the protective tape may be formed of an engineering plastic material. As a specific example, a region where the device 200 for attaching a tape comes into contact with the electrode assembly may be formed of a material having a low coefficient of friction, such as polyetheretherketone (PEEK), polyoxymethylene (POM), or polyethylene (PE). Accordingly, the electrode assembly and/or the protective tape may be prevented from being damaged by friction during contact with the device for attaching a tape.

The configuration of the device 200 for attaching a tape illustrated in FIG. 2 is only an example, and in some embodiments, configurations other than those illustrated may be additionally included, and some configurations may be omitted. In a case where some of the above configurations are omitted, the functions of the omitted configurations may be performed by other configurations than the illustrated configurations.

FIGS. 3 to 7 illustrate stages in a method for attaching a tape according to an embodiment of the present disclosure.

Referring to FIG. 3, the device 200 for attaching a tape may include the support block 210, the bending block 220, and the bending roller 230.

An electrode assembly 110 may be disposed on the support block 210. A protective tape 122 may be attached to one surface of the electrode assembly 110. The protective tape 122 may be attached to protrude from a specific surface of the electrode assembly 110. For example, referring to FIG. 3, the protective tape 122 may extend on and along a specific surface of the electrode assembly 110, and may extend beyond (e.g., overhang) the specific surface of the electrode assembly 110.

For convenience of explanation, based on the vertical direction (Z-axis) in FIG. 3, one surface of the electrode assembly 110 to which the protective tape 122 is attached is referred to as the lower surface, and the direction of the surface to which the protective tape 122 is attached is referred to as the lower direction. In addition, the surface of the electrode assembly 110 facing the lower surface is referred to as the upper surface, and the direction facing the lower surface is referred to as the upper direction. Based on the horizontal direction (X-axis), the direction in which the protective tape 122 protrudes from the electrode assembly 110 is referred to as the lateral direction.

The support block 210 may support the lower surface of the electrode assembly 110. For example, the electrode assembly 110 may be spaced apart above the support block 210. Thereafter, as the electrode assembly 110 moves downward (e.g., toward the support block 210 along the arrow), the lower surface of the electrode assembly 110 may be disposed on (e.g., directly on) the support block 210. The support block 210 may support the lower surface of the electrode assembly 110 at the bottom of the electrode assembly 110.

In an embodiment, a second width w2, which is the width of the support block 210 in the horizontal direction (X-axis), may be larger than a first width w1, which is the width of the lower surface of the electrode assembly 110. Accordingly, the support block 210 may stably support the lower surface of the electrode assembly 110.

In an embodiment, at least a portion of the support block 210 supporting the lower surface of the electrode assembly 110 may be formed of an engineering plastic material. For example, the surface of the support block 210 that directly contacts the lower surface of the electrode assembly 110 may be formed of an engineering plastic material. Accordingly, during the process of disposing the electrode assembly 110 on the support block 210, the surface of the electrode assembly 110 may be prevented from being damaged.

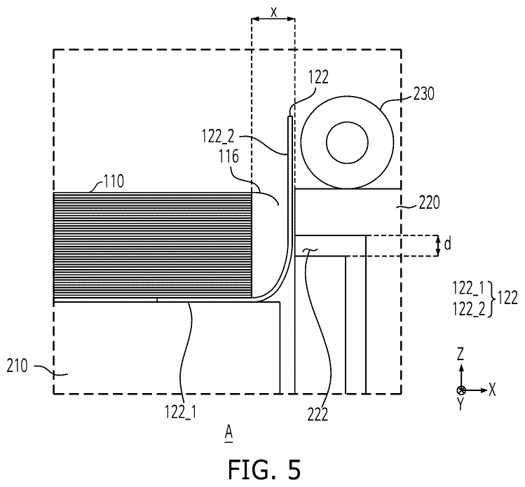

The bending block 220 may be spaced apart in the lateral direction (X-axis) of the support block 210, e.g., the bending block 220 may be on opposite sides of the support block 210 in the lateral direction (X-axis). As the bending block 220 is spaced apart from the support block 210, the electrode assembly 110 disposed on the support block 210 may also be spaced apart from the bending block 220. An example of the distance between the side surface of the electrode assembly 110 and the support block 210 is described in detail below with reference to FIG. 5.

In an embodiment, as the protective tape 122 is attached to protrude in the lateral direction of the electrode assembly 110, a third width w3, which is the width of the electrode assembly 110 including the protruding length of the protective tape 122, may be larger than the second width w2, which is the width of the support block 210. In some embodiments, the third width w3 may be larger than a fourth width w4, which is the sum of the width of the support block 210 and the distance the support block 210 is spaced from the bending block 220.

Accordingly, as the electrode assembly 110 moves downward, the protective tape 122 protruding from the electrode assembly 110 may be bent in the space between the support block 210 and the bending block 220. The protective tape 122 may be bent to face (e.g., toward) the side surface of the electrode assembly 110. In some embodiments, the protective tape 122 may be bent to contact (e.g., directly contact) the side surface of the bending block 220. An example in which the protective tape 122 is bent is described below with reference to FIGS. 4 to 6.

Referring to FIG. 4, the protective tape 122 bent to face the side surface of the electrode assembly 110 may be attached to the side surface of the electrode assembly 110.

The bending block 220 may include air spray holes 222. The air spray holes 222 may be disposed to face the side surface of the electrode assembly 110 in a case where the electrode assembly 110 is disposed on the support block 210. For example, referring to FIG. 4, the bending block 220 may extend above the support block 210 (e.g., a topmost surface of the bending block 220 may be at a higher level than a topmost surface of the support block 210 relative to the bottom of the support block 210), such that the air spray holes 222 in the bending block 220 may face a region above the topmost surface of the support block 210. Compressed air may be sprayed onto the side surface of the electrode assembly 110 through the air spray holes 222, and the protective tape 122 may be moved by the compressed air toward the side surface of the electrode assembly 110 to come into close contact (e.g., direct contact) with the side surface of the electrode assembly 110.

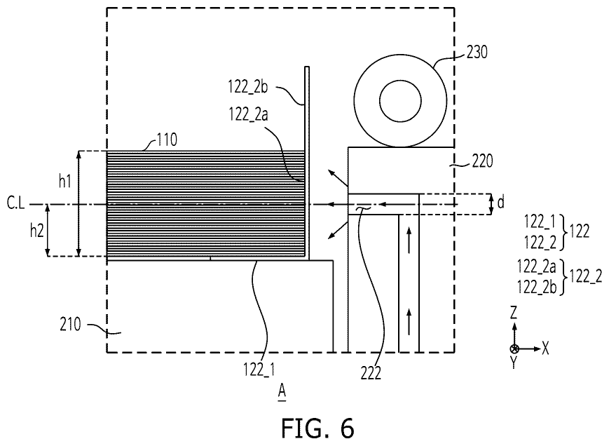

FIGS. 5 and 6 illustrate an example in which the protective tape 122 comes into close contact with the side surface of the electrode assembly 110. For reference, FIGS. 5 and 6 illustrate enlarged views of a region A of FIG. 4.

Referring to FIG. 5, in a case where the electrode assembly 110 is disposed on the support block 210, the protective tape 122 attached to the lower surface of the electrode assembly 110 may be bent to face the side surface of the electrode assembly 110.

For example, a first section 122_1 of the protective tape 122 may be attached to the lower surface of the electrode assembly 110, and a second section 122_2 of the protective tape 122 connected to the first section 122_1 may be bent to face the side surface of the electrode assembly 110. In some embodiments, the second section 122_2 of the protective tape 122 may be bent to come into contact with the side surface of the bending block 220.

In an embodiment, at least a portion of the bending block 220 may be formed of an engineering plastic material. For example, the surface of the bending block 220 that comes into direct contact with the protective tape 122 may be formed of an engineering plastic material. Accordingly, the surface of the protective tape 122 may be prevented from being damaged during the process of bending the protective tape 122.

In an embodiment, the bending block 220 may be spaced apart from the side surface of the electrode assembly 110 by a specific distance x. In a case where the bending block 220 is spaced apart from the side surface of the electrode assembly 110 by less than the specific distance x, a phenomenon in which the separator 116 is reversed may occur. For example, the separator 116 may be damaged in a case where it is not in close contact with the side surface of the electrode assembly 110, but in a bent state in close contact with the upper surface of the electrode assembly 110. In some embodiments, in a case where the protective tape 122 is attached while the separator 116 is bent, poor exterior of the electrode assembly 110 may occur.

In some embodiments, in a case where the bending block 220 is spaced apart from the side surface of the electrode assembly 110 by more than the specific distance x, the compressed air sprayed from the air spray holes 222 of the bending block 220 may be dispersed, thereby reducing the close contact effect of the protective tape 122.

Accordingly, the bending block 220 may be spaced apart from the side surface of the electrode assembly 110 by the specific distance x. For example, in order that the separator 116 protruding from the side surface of the electrode assembly 110 does not interfere with the protective tape 122, the specific distance x, by which the bending block 220 is spaced from the side surface of the electrode assembly 110, may be longer than the length by which the separator 116 protrudes from the side surface of the electrode assembly 110. For example, the specific distance x, by which the bending block 220 is spaced from the side surface of the electrode assembly 110, may be 1 mm to 2 mm.

Referring to FIG. 6, the protective tape 122 bent to face the side surface of the electrode assembly 110 may be attached to the side surface of the electrode assembly 110. The protective tape 122 may come into close contact (e.g., direct contact) with the side surface of the electrode assembly 110 by compressed air sprayed from the air spray holes 222 of the bending block 220.

For example, in the second section 122_2 of the protective tape 122 bent to face the side surface of the electrode assembly 110, a first sub-section 122_2a adjacent to the first section 122_1 may come into close contact with the side surface of the electrode assembly 110. In some embodiments, in the second section 122_2 of the protective tape 122, a second sub-section 122_2b adjacent to the first sub-section 122_2a may protrude toward the upper surface of the electrode assembly 110. For example, referring to FIG. 6, the first sub-section 122_2a may be between and integral with the first section 122_1 and the second sub-section 122_2b, and the second sub-section 122_2b may protrude (e.g., extend) above the topmost surface of the electrode assembly 110.

In an embodiment, the air spray holes 222 may be formed on the side surface of the bending block 220 and may be disposed to face the side surface of the electrode assembly 110 (e.g., to face the first sub-section 122_2a of the second section 122_2). For example, the air spray holes 222 may be circular or any suitable shape, e.g., an oval or a polygon.

In an embodiment, based on the height direction (Z-axis) of the electrode assembly 110, the air spray holes 222 may be disposed at (e.g., aligned with) a center line C. L of the electrode assembly 110. For example, the air spray holes 222 (e.g., a center of the air spray hole 222) may be disposed at a height h2 corresponding to (e.g., equal to) half of a height h1 of the side surface of the electrode assembly 110. In a case of attaching the protective tape 122, the protective tape 122 may effectively come into contact with the side surface of the electrode assembly 110 by disposing the air spray holes 222 at the position where the greatest displacement of the protective tape 122 occurs.

In an embodiment, the diameter d of the air spray hole 222 may be formed to be 20% to 30% of the height h1 of the electrode assembly 110. In a case where the diameter d of the air spray hole 222 is less than 20% of the height h1 of the electrode assembly 110, the compressed air sprayed through the air spray hole 222 may locally act only on a part of the side surface of the electrode assembly 110, which may be insufficient to completely attach (e.g., put in direct contact) the protective tape 122 with the side surface of the electrode assembly 110. In some embodiments, in a case where the diameter d of the air spray hole 222 exceeds 30% of the height h1 of the electrode assembly 110, the compressed air sprayed through the air spray hole 222 may be dispersed, causing the pressure distribution applied to the side surface of the electrode assembly 110 to become uneven. Accordingly, the diameter d of the air spray hole 222 may be formed to be 20% to 30% of the height h1 of the electrode assembly 110, and additionally, the diameter d of the air spray hole 222 may be 2 mm or less.

In an embodiment, the pressure of the compressed air sprayed through the air spray holes 222 may be 0.1 MPa to 0.3 MPa.

Referring to FIG. 7, the bending roller 230 may move along the upper surface of the electrode assembly 110 and attach the protective tape 122 to the upper surface of the electrode assembly 110. The bending roller 230 may move left and right with respect to the horizontal direction (X-axis). The bending roller 230 may move along the upper surface of the electrode assembly 110 in the left-and-right direction and attach the protective tape 122 to the upper surface of the electrode assembly 110. For example, referring to FIG. 7, the bending roller 230 may be above the support block 210 and above the bending block 220, and may be movable in the horizontal direction (e.g., in the X-axis direction) in parallel to topmost surfaces of the support block 210 and above the bending block 220.

For example, in the second section 122_2 of the protective tape 122, in a state in which the first sub-section 122_2a adjacent to the first section 122_1 is in close contact with the side surface of the electrode assembly 110 and the second sub-section 122_2b adjacent to the first sub-section 122_2a protrudes toward the upper surface of the electrode assembly 110, the bending roller 230 may pressurize (e.g., press) the second sub-section 122_2b of the protective tape 122 while moving along the upper surface of the electrode assembly 110. Accordingly, the second sub-section 122_2b of the protective tape 122 may be bent and attached to the upper surface of the electrode assembly 110.

In an embodiment, at least a portion of the bending roller 230 may be formed of an engineering plastic material. For example, the surface of the bending roller 230 that directly contacts the upper surface of the protective tape 122 and/or the electrode assembly 110 may be formed of an engineering plastic material. Accordingly, the surface of the protective tape 122 and/or the electrode assembly 110 may be prevented from being damaged during the process in which the protective tape 122 is pressurized by the bending roller 230.

In an embodiment, compressed air may be continuously blown from the bending block 220 while the bending roller 230 moves along the upper surface of the electrode assembly 110. For example, compressed air may be continuously sprayed from the time at which attachment of the protective tape 122 to the side surface of the electrode assembly 110 begins to the time at which attachment of the protective tape 122 to the upper surface of the electrode assembly 110 ends. Accordingly, the protective tape 122 may come into close contact with the corner portion where the side surface and the upper surface of the electrode assembly 110 meet without lifting.

For example, referring to FIGS. 3 to 7, the air spray holes 222 may be disposed in one row with respect to the height direction (Z-axis) of the bending block 220. In another example, the air spray holes 222 may be disposed in a plurality of rows.

In FIGS. 3 to 7, the bending blocks 220 are illustrated as being spaced apart from each other on both side surfaces of the support block 210 with respect to the lateral direction (X-axis) of the support block 210, but the bending blocks 220 may be spaced apart from each other on only one side surface of the support block 210. In some embodiments, the bending block 220 may be additionally spaced apart from the front and/or rear surfaces of the support block 210 with respect to the front-and-back direction (Y-axis) of the support block 210.

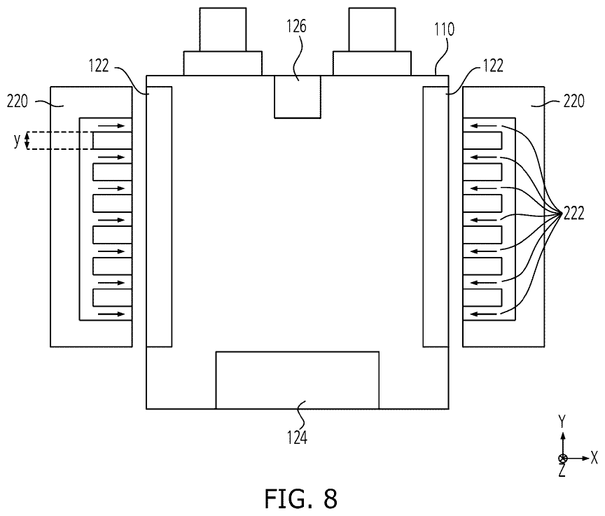

FIG. 8 illustrates a plan view showing an example of the bending block 220 according to an embodiment of the present disclosure. Referring to FIG. 8, the air spray holes 222 may be included in the bending block 220. The air spray holes 222 may be spaced apart from each other along the longitudinal direction (Y-axis) of the side surface of the electrode assembly 110. In an embodiment, the separation distance y between the air spray holes 222 may be 4 mm to 6 mm.

In FIG. 8, only an example of attaching the protective tape 122 to both side surfaces of the electrode assembly 110 is illustrated. For example, the lower protective tape 124 and the upper protective tape 126 attached to the side surface of the electrode assembly 110 may also be attached by the device for attaching a tape according to the present disclosure.

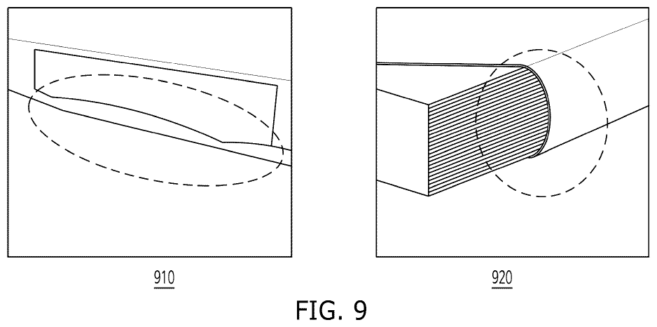

FIG. 9 illustrates a battery cell manufactured by a device for attaching a tape according to a comparative example.

A first example 910 illustrates the protective tape attached to one side surface of the electrode assembly with the separator inverted. Specifically, the separator protruding from the side surface of the electrode assembly is in close contact with another surface adjacent to the side surface other than the side surface of the electrode assembly. In this case, the separator may be damaged by bending. In addition, it may cause problems with the exterior of the battery.

To prevent this problem, the bending block may be spaced apart from the side surface of the electrode assembly by an appropriate distance. For example, to prevent the separator protruding from the side surface of the electrode assembly from interfering with the protective tape, the bending block may be spaced apart from the side surface of the electrode assembly by a length greater than the protruding length of the separator. The bending block may be spaced from the side surface of the electrode assembly by, e.g., 1 mm to 2 mm.

A second example 920 illustrates a case where the protective tape is lifted without being in close contact with the side surface of the electrode assembly. In this case, poor insertion of the electrode assembly may occur. This problem may be solved by forming air spray holes in the bending block and spraying compressed air while attaching the protective tape to the side surface of the electrode assembly.

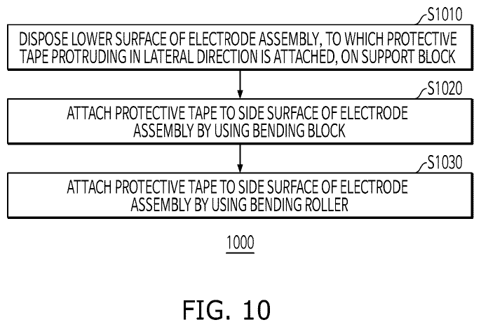

FIG. 10 illustrates a flowchart showing a method 1000 for attaching a tape according to an embodiment of the present disclosure. The method 1000 for attaching a tape may be started by disposing the lower surface of the electrode assembly, to which the protective tape protruding in the lateral direction is attached, on the support block (S1010). For example, the first section of the protective tape may be attached to the lower surface of the electrode assembly, and the second section connected to the first section may protrude in the lateral direction of the electrode assembly. In this case, the second section of the protective tape may be disposed to be bent so as to face the side surface of the electrode assembly.

Thereafter, the protective tape may be attached to the side surface of the electrode assembly by using the bending block (S1020). The bending block may include the air spray holes disposed to face the side surface of the electrode assembly, and the protective tape may be adhered to the side surface of the electrode assembly by compressed air sprayed through the air spray holes. For example, in the second section of the protective tape, the first sub-section adjacent to the first section may be attached in close contact with the side surface of the electrode assembly, and the second sub-section adjacent to the first sub-section of the second section may be attached to protrude toward the upper surface of the electrode assembly.

In an embodiment, the bending block may be disposed spaced apart from the side surface of the electrode assembly. For example, the separator may protrude from the side surface of the electrode assembly, and the distance by which the bending block is spaced from the side surface of the electrode assembly may be longer than the length by which the separator protrudes from the side surface of the electrode assembly.

In an embodiment, the pressure of the compressed air sprayed through the air spray holes may be 0.1 MPa to 0.3 MPa. In some embodiments, the air spray hole may be disposed at a height corresponding to half the height of the side surface of the electrode assembly. In some embodiments, the diameter of the air spray hole may be 2 mm or less.

Thereafter, the protective tape may be attached to the side surface of the electrode assembly by using the bending roller (S1030). The bending roller may move along the upper surface of the electrode assembly to attach the second sub-section of the protective tape to the upper surface of the electrode assembly.

The flowchart of FIG. 10 and the above description are only examples of the present disclosure. For example, one or more steps in the flowchart and the above description may be added/changed/deleted, the order of one or more steps may be changed, and one or more steps may be performed simultaneously.

By way of summation and review, if a protective tape is not properly attached to a surface of an electrode assembly, the electrode assembly may be damaged by external impact, or the electrode assembly may not be inserted properly during a battery assembling process. In contrast, aspects of embodiments of the present disclosure provide a device and method for properly attaching a tape for a secondary battery.

That is, according to some embodiments of the present disclosure, the protective tape may come into close contact with the side surface of the electrode assembly without lifting by spraying compressed air through air spray holes formed on the side surface of the bending block. According to some embodiments of the present disclosure, the surface of the device for attaching a tape that directly contacts the electrode assembly and/or the protective tape may be formed of an engineering plastic material, thereby preventing the electrode assembly and/or the protective tape from being damaged by friction with the device for attaching a tape.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A device for attaching a tape, the device comprising:
a support block configured to support a lower surface of an electrode assembly to which a protective tape is attached;
a bending block spaced apart from a side surface of the support block, the bending block including at least one air spray hole facing the side surface of the support block and a side surface of the electrode assembly, and the bending block being configured to attach the protective tape to the side surface of the electrode assembly; and
a bending roller above the bending block, the bending roller being movable along an upper surface of the bending block and an upper surface of the electrode assembly to attach the protective tape to the upper surface of the electrode assembly.

2. The device as claimed in claim 1, wherein:
the protective tape protrudes in a lateral direction from the electrode assembly toward the bending block, and
the bending block is configured to bend the protective tape toward the side surface of the electrode assembly and to spray compressed air toward the protective tape through the at least one air spray hole.

3. The device as claimed in claim 2, wherein a pressure of the compressed air sprayed through the at least one air spray hole is 0.1 MPa to 0.3 MPa.

4. The device as claimed in claim 2, wherein the at least one air spray hole is at a height corresponding to half of a height of the side surface of the electrode assembly.

5. The device as claimed in claim 2, wherein a diameter of the at least one air spray hole is 20% to 30% of a height of the side surface of the electrode assembly.

6. The device as claimed in claim 2, wherein a diameter of the at least one air spray hole is 2 mm or less.

7. The device as claimed in claim 2, wherein the bending block is spaced apart from the side surface of the electrode assembly by a distance that is longer than a length by which the separator protrudes from the side surface of the electrode assembly.

8. The device as claimed in claim 7, wherein the distance is 1 mm to 2 mm.

9. The device as claimed in claim 1, wherein the at least one air spray hole includes a plurality of spray holes spaced apart from each other along a length direction of the side surface of the electrode assembly.

10. The device as claimed in claim 9, wherein a separation distance between the plurality of air spray holes is 4 mm to 6 mm.

11. The device as claimed in claim 1, wherein the bending roller is configured to pressurize the protective tape protruding toward an upper surface of the electrode assembly while bending the protective tape along the upper surface of the electrode assembly.

12. The device as claimed in claim 1, wherein at least a portion of a region where the support block, the bending block, or the bending roller comes into contact with the electrode assembly or the protective tape includes an engineering plastic material.

13. A method for attaching a tape, the method comprising:
disposing, on a support block, a lower surface of an electrode assembly to which a protective tape protruding in a lateral direction is attached;
attaching the protective tape to a side surface of the electrode assembly by using a bending block; and
attaching the protective tape to an upper surface of the electrode assembly by using a bending roller,
wherein the bending block includes at least one air spray hole facing the side surface of the electrode assembly, and
wherein the protective tape comes into close contact with the side surface of the electrode assembly by compressed air sprayed through the at least one air spray hole.

14. The method as claimed in claim 13, wherein:
a first section of the protective tape is attached to the lower surface of the electrode assembly, and a second section connected to the first section protrudes in a lateral direction of the electrode assembly, and
disposing includes disposing the second section of the protective tape so as to be bent to face the side surface of the electrode assembly.

15. The method as claimed in claim 14, wherein attaching the protective tape to the side surface of the electrode assembly includes bringing a first sub-section of the second section adjacent to the first section into close contact with the side surface of the electrode assembly, such that a second sub-section of the second section of the protective tape adjacent to the first sub-section protrudes toward the upper surface of the electrode assembly.

16. The method as claimed in claim 15, wherein attaching the protective tape to the upper surface of the electrode assembly includes attaching the second sub-section of the protective tape to the upper surface of the electrode assembly while the bending roller moves along the upper surface of the electrode assembly.

17. The method as claimed in claim 13, wherein a pressure of the compressed air sprayed through the at least one air spray hole is 0.1 MPa to 0.3 MPa.

18. The method as claimed in claim 13, wherein the at least one air spray hole is at a height corresponding to half of a height of the side surface of the electrode assembly.

19. The method as claimed in claim 13, wherein a diameter of the at least one air spray hole is 2 mm or less.

20. The method as claimed in claim 13, wherein a separator of the electrode assembly protrudes from the side surface of the electrode assembly, a distance by which the bending block is spaced apart from the side surface being longer than a length by which the separator protrudes from the side surface.
